(19) United States
(12) Patent Application Publication
(10) Pub. No.: US 2001/0047319 A1
(43) Pub. Date: Nov. 29, 2001

(54) Data linking system

(75) Inventors: Masayuki Tada, Kawasaki (JP); Masaru Araki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/813,553

(22) Filed: Mar. 21, 2001

(30) Foreign Application Priority Data
May 24, 2000 (JP) 2000-153633

(51) Int. Cl. G06F 17/60

(52) U.S. Cl. 705/35; 705/42

(57) ABSTRACT

There is disclosed a data linking system which efficiently links data for improved performance and quality of the system. A data storage device stores data. A transmitter-side storage information management device manages storage information concerning control of storage of the data in the data storage device. A transmitter-side storage information interface device transmits and receives the storage information for linkage with a receiver side. A data writing device writes the data into the data storage device based on the storage information. A receiver-side storage information management device manages the storage information concerning control of storage of the data in the data storage device. A receiver-side storage information interface device transmits and receives the storage information for linkage with the transmitter side. A data reading device reads the data from the data storage device based on the storage information.

### BACKGROUND OF THE INVENTION

1. Field of the Invention

The present invention relates to a data linking system, and more particularly to a data linking system which makes it possible to link data between a transmitter side and a receiver side.

2. Description of the Related Art

In recent years, an operating system is required to deal with a very larger amount of data having a very complicated correlation therebetween, so that there is an increasing demand for a sophisticated data management facility which is more efficient and user-friendly. Under the circumstances, systems are widely employed which make use of a database enabling management of a large amount of data. In such a database system, business-application programs and data accumulated therefor are composed independently of each other, so that sophisticated data processing can be performed.

When attention is paid to conventional manners of providing databases, database services can be classified into the off line database service and the online database service.

In the offline database service, a database of information is provided in a state stored in a medium, such as a magnetic recording tape, a floppy disk, or the like, while in the online database service, information is provided from a transmitting server as a database host system to receiving servers connected to the transmitting server by a communication line.

However, the above conventional offline database service is not suitable for systems in which data are updated frequently. Further, since it is required to use manpower to carry and manage the medium, the service is not efficient or economical.

On the other hand, the conventional online database service is widely employed in systems used e.g. in the finance industry, in which data are required to be updated frequently. In this service, however, when a load on a communication line is increased, a delay occurs in operation of a program used by the transmitting server which delivers data to the receiving servers. Further, the transmitting server and the receiving servers each have to store and manage identical data files, in a duplicating manner, which makes the online service inefficient in the use of resources.

### SUMMARY OF THE INVENTION

The present invention has been made in view of these inconveniences, and hence an object thereof is to provide a data linking system which efficiently links data for improved performance and quality of the system.

To attain the above object, the present invention provides a data linking system for linking data between a transmitter side and a receiver side. This data linking system is characterized by comprising a data storage device for storing data; a transmitter-side data linking apparatus including transmitter-side storage information management means for managing storage information concerning control of storage of the data in the data storage device, transmitter-side storage information interface means for transmitting and receiving the storage information for linkage with the receiver side, and data writing means for writing the data into the data storage device based on the storage information; and a receiver-side data linking apparatus including receiver-side storage information management means for managing the storage information concerning control of storage of the data in the data storage device, receiver-side storage information interface means for transmitting and receiving the storage information for linkage with the transmitter side, and data reading means for reading the data from the data storage device based on the storage information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing operating principles of a data linking system according to the present invention;

FIG. 2 is a diagram showing a manner of storing data files in the data storage means;

FIG. 3 is a diagram showing an example of a data format;

FIG. 4 is a flowchart showing a procedure of the overall operation of the data linking system;

FIG. 5 is a diagram showing the construction of a financial information processing system according to the invention;

FIG. 6 is a conceptual representation of a first embodiment of the financial information processing system; and

FIG. 7 is a conceptual representation of a second embodiment of the financial information processing system.

### DESCRIPTION OF THE PREFERRED EMBODIMENTS

Preferred embodiments of the present invention will now be described below with reference to accompanying drawings.

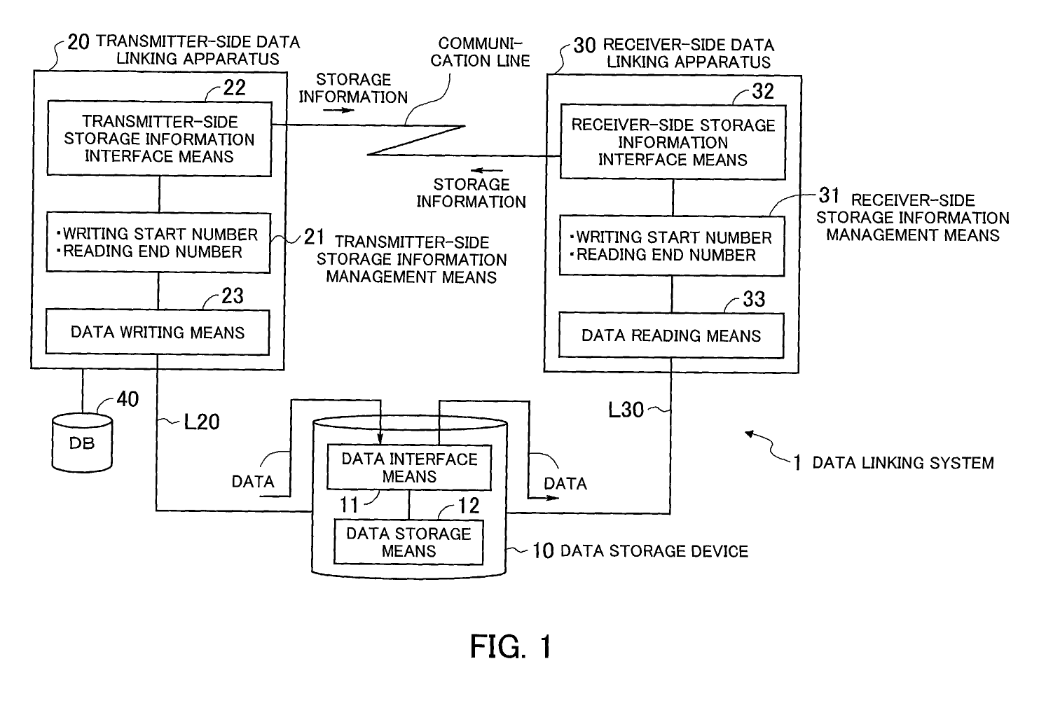

FIG. 1 shows the operating principles of a data linking system of the present invention. The data linking system 1 is comprised of a data storage device 10, a transmitter-side data linking apparatus 20 as a base system having a database (DB) 40, and a receiver-side data linking apparatus 30 as an information system for users or customers. The system 1 performs necessary operations through linking of data between the apparatuses 20 and 30.

The data storage device 10 is connected to the apparatuses 20 and 30 by respective communication lines L20, L30. The data storage device 10 includes a data interface means 11 that interfaces with the transmitter-side data linking apparatus 20 for writing of data by the apparatus into the data storage device 10 and with the receiver-side data linking apparatus 30 for reading of data by the apparatus 30 from the data storage device 10, and a data storage means 12 that stores data.

In this system, the data stored in the data storage means 12 corresponds to information of history of updates of the DB 40 effected by transaction processing and the like.

The transmitter-side data linking apparatus 20 includes a transmitter-side storage information management means 21 that manages storage information for control of storage of data in the data storage device 10.

The storage information includes information of a writing start number for use in writing data and a reading end number for use in reading the same. The writing start number is a number representative of a data item that is to be written in the data storage device 10 next time, while the reading end number is a number representative of a data item that has been read out from the data storage device 10.

A transmitter-side storage information interface means 22 of the apparatus 20 is connected to a receiver-side storage information interface means 32 of the receiver-side data linking apparatus 30 via a communication line. The transmitter-side storage information interface means 22 transmits storage information to the receiver-side data linking apparatus 30, and receives storage information from the same, for linkage between the two apparatuses 20 and 30. The transmitter-side data linking apparatus 20 also includes a data writing means 23 that writes data into the data storage device 10 via the communication line L20 based on the storage information.

The receiver-side data linking apparatus 30 includes a receiver-side storage information management means 31 that manages storage information of control of storage of data in the data storage device 10.

The receiver-side storage information interface means 32 of the apparatus 30 is connected to the transmitter-side storage information interface means 22 of the transmitter-side data linking apparatus 20 via the communication line, as described above. The receiver-side storage information interface means 32 transmits storage information to the transmitter-side data linking apparatus 20 and receives storage information from the same, for linkage between the two apparatuses 20 and 30. The receiver-side data linking apparatus 30 includes a data reading means 33 that reads data from the data storage device 10 via the communication line L30 based on the storage information.

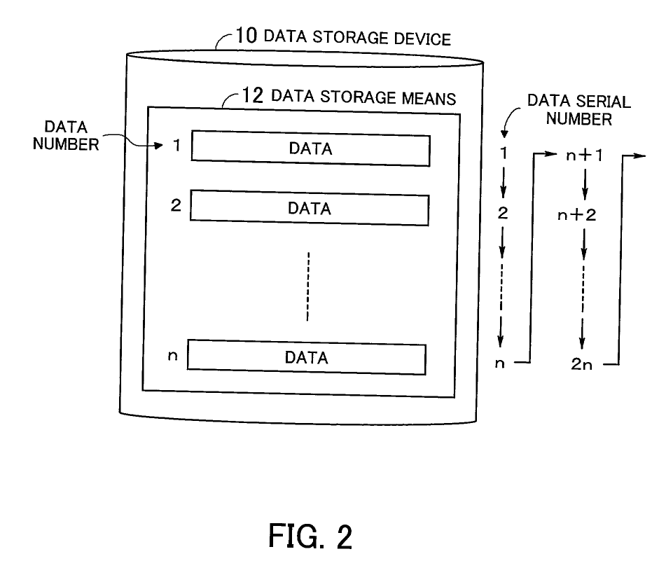

Next, the data storage device 10 will be described. FIG. 2 shows how data are stored in the data storage means 12. The data stored in the data storage means 12 takes the form of files. Each data item (i.e. file) is stored with a data number (within a range of 1 to n) assigned thereto. Further, as shown in FIG. 2, each data item has a serial number (1 to n, n+1 to 2n, . . . ) assigned thereto which is used as a writing start number or a reading end number.

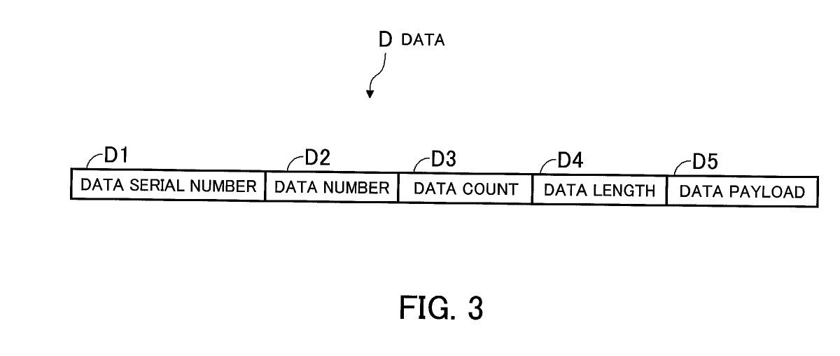

FIG. 3 shows an example of a data format of data stored in the data storage means 12. A data item D is formed of an above-mentioned data serial number D1, an above-mentioned data number D2, a data count D3 indicative of the number of files stored in the data storage means 12, a data length D4, and a data payload D5 as real information.

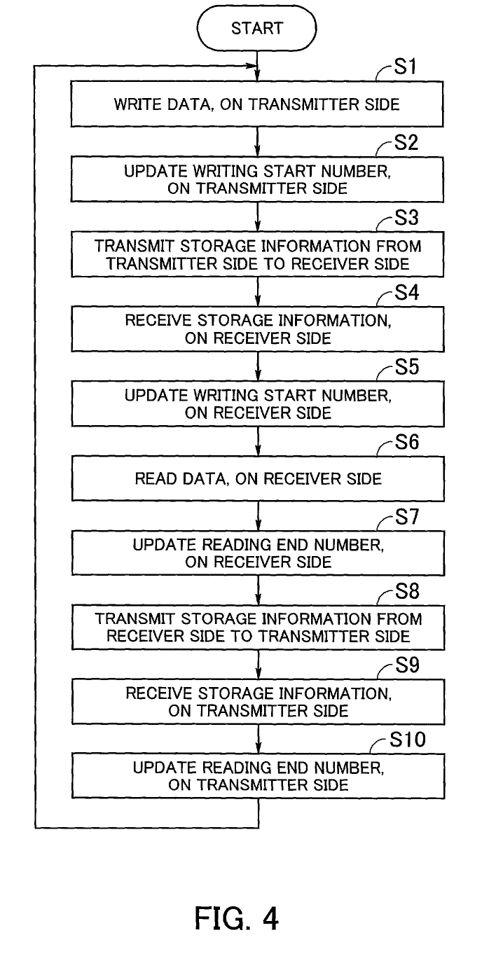

Next, the overall operation of the data linking system 1 will be described. FIG. 4 is a flowchart showing a procedure of the operation of the data linking system 1. In this flowchart, the “transmitter side” and the “receiver side” represent the transmitter-side data linking apparatus 20 and the receiver-side data linking apparatus 30, respectively.

[S1] The data writing means 23 writes data into the data storage device 10 based on the present storage information (writing start number and reading end number) under management of the transmitter-side storage information management means 21.

[S2] The transmitter-side storage information management means 21 updates the writing start number of the storage information under its own management. For example, when a data item having data serial number 2 is written into the data storage device 10, the writing start number is updated to 3 (data serial number 3).

[S3] The transmitter-side storage information interface means 22 transmits the storage information updated by the transmitter-side storage information management means 21 to the receiver-side data linking apparatus 30.

[S4] The receiver-side storage information interface means 32 receives the storage information from the transmitter-side data linking apparatus 20 and notifies the receiver-side storage information management means 31 of the contents of the received storage information.

[S5] The receiver-side storage information management means 31 updates the writing start number of the storage information under its own management.

[S6] The data reading means 33 reads data from the data storage device 10 based on the updated storage information under management of the receiver-side storage information management means 31.

[S7] The receiver-side storage information management means 31 updates the reading end number of the storage information under its own management. For example, when the data item having data serial number 2 is read, the reading end number is updated to 2 (data serial number 2).

[S8] The receiver-side storage information interface means 32 transmits the storage information updated by the receiver-side storage information management means 31 to the transmitter-side data linking apparatus 20.

[S9] The transmitter-side storage information interface means 22 receives the storage information from the receiver-side data linking apparatus 30 and notifies the transmitter-side storage information management means 21 of the contents of the received storage information.

[S10] The transmitter-side storage information management means 21 updates the reading end number of the storage information under its own management. The control process returns to the step S1, for repeatedly executing the same procedure as described above.

The storage information is thus exchanged between the transmitter-side storage information interface means 22 and the receiver-side storage information interface means 32, whereby the storage information under the management of the transmitter-side storage information management means 21 and that under the management of the receiver-side storage information management means 31 are updated to assume identical values.

Then, the transmitter-side data linking apparatus 20 writes data in the data storage device 10 shared by the apparatuses 20 and 30 based on its own storage information, and the receiver-side data linking apparatus 30 reads data from the same based on its own storage information.

As described above, logically, identical data is stored and controlled in each of the transmitter side and the receiver side (actually, the single data storage device 10 is shared by the transmitter side and the receiver side for control of data storage), whereby it is possible to obtain the same effects as obtained when a large amount of data is transferred at a high speed from the transmitter-side data linking apparatus 20 to the receiver-side data linking apparatus 30.

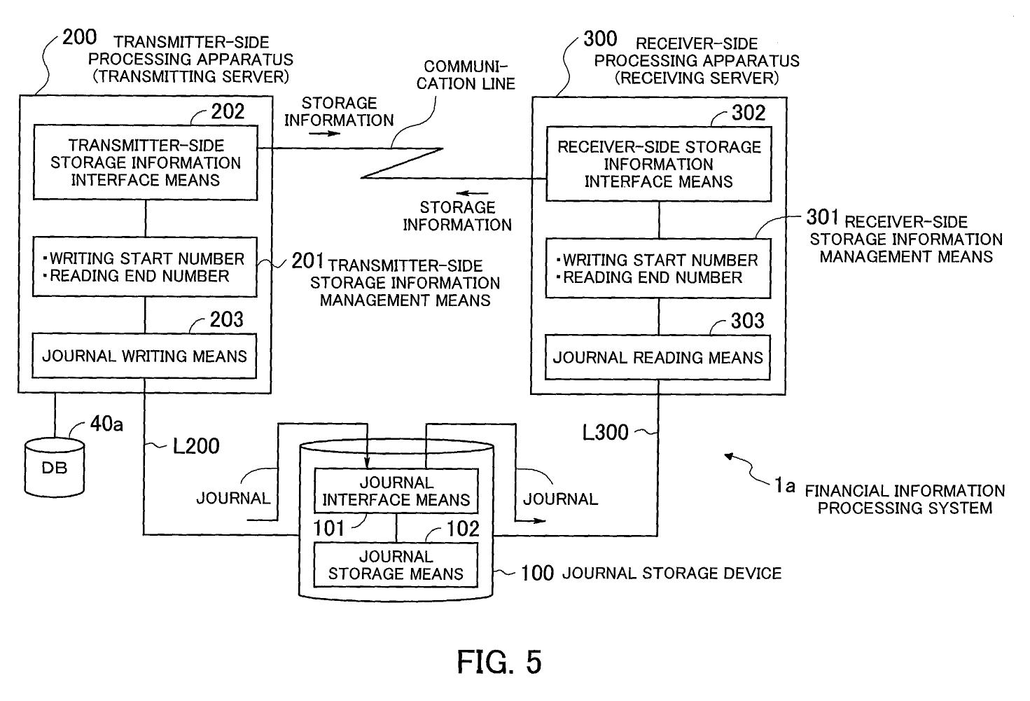

Next, description will be made of a financial information processing system employed in a finance institution, to which is applied the data linking system 1 according to the invention. FIG. 5 shows the arrangement of the financial information processing system according to the present invention.

The financial information processing system 1a is comprised of a journal storage device 100, a transmitter-side processing apparatus 200 (hereinafter simply referred to as “the transmitting server 200”) having a database (DB) 40a, and a receiver-side processing apparatus 300 (hereinafter simply referred to as “the receiving server 300”). The financial information processing system 1a performs necessary operations by linking journals between the servers 200 and 300. The journal storage device 100 is connected to the transmitting server 200 and the receiving server 300 by respective communication lines L200, L300.

The term “journal” used here means information of history of updates of the DB 40a effected by transaction processing and the like. It should be noted that the component parts of the financial information processing system 1a correspond to those of the FIG. 1 data linking system 1.

The journal storage device 100 includes journal interface means 101 that interfaces with the transmitting server 200 for writing of data by the server 200 into the journal storage device 100 and with the receiving server 300 for reading of data by the server 300 from the journal storage device 100, and journal storage means 102 that stores the journal. The journal storage device is shared by the transmitting server 200 and the receiving server 300.

Journal writing means 203 of the transmitting server 200 writes journals in the journal storage device 100 via the communication line L200. Then, transmitter-side storage information management means 201 updates a writing start number in preparation for the following writing operation.

Further, since storage information is required to be updated in a manner interlocked between the two servers, transmitter-side storage information interface means 202 transmits the storage information managed by the transmitter-side storage information management means 201 to the receiving server 300 via a communication line connecting the servers.

Receiver-side storage information interface means 302 of the receiving server 300 notifies receiver-side storage information management means 301 of the writing start number of the storage information received from the interface means 202. The receiver-side storage information management means 301 updates its own storage information based on the received storage information and instructs journal reading means 303 of the receiving apparatus to read journals based on the updated storage information.

The journal reading means 303 reads journals up to a journal having a number immediately before the writing start number (e.g. when the writing start number is 4, it is possible to read up to a journal No. 3) via the communication line L300.

When the journal reading means 303 completes the reading of the journals, the receiver-side storage information management means 301 updates the reading end number of the storage information under its own control. The receiver-side storage information interface means 302 transmits the storage information updated by the receiver-side storage information management means 301 to the transmitting server 200.

The transmitter-side storage information interface means 202 of the transmitting server 200 passes the storage information received from the receiver-side storage information interface means 302 to the transmitter-side storage information management means 201. The transmitter-side storage information management means 201 updates the reading end number of the storage information under its own management.

The journal writing means 203 recognizes the number of journals which can be written into the journal storage device 100, based on the updated reading end number, and writes journals in the journal storage device 100 via the communication line L200.

Under the above control, the storage information of journal files is transferred from the transmitting server 200 to the receiving server 300, and writing and reading of journals is continuously performed, whereby it is possible to make efficient use of the shared journal files.

Next, a first embodiment of the financial information processing system 1a will be described, by way of example, in which a transmitting server 200 performs accounting-related operations and a receiving server 300 performs information-related operations.

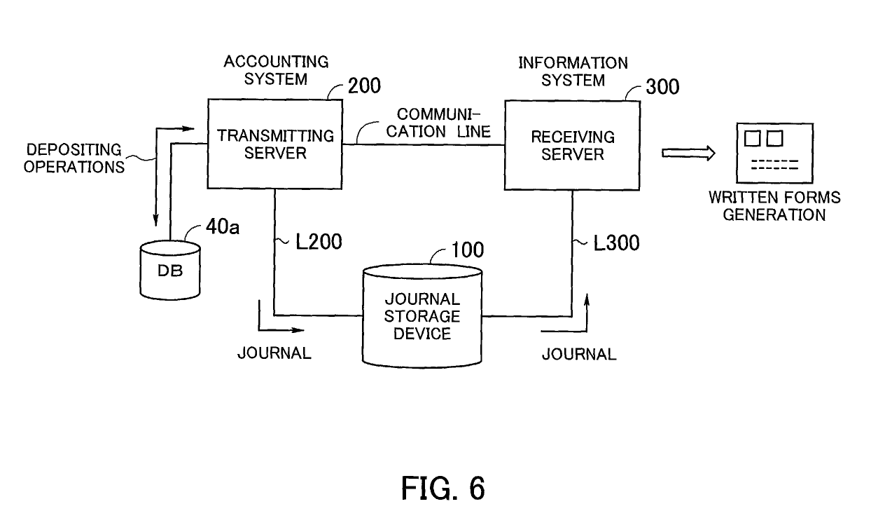

FIG. 6 is a conceptual representation of the first embodiment. The transmitting server 200, which has a DB 40a, and the receiving server 300 share a journal storage device 100. Further, the transmitting server 200 and the receiving server 300 are connected by a communication line for transferring storage information of journals. The journal storage device 100 is connected to the transmitting server 200 and the receiving server 300 via respective communication lines L200, L300, respectively.

The transmitting server 200 performs, for example, depositing operations as accounting-related operations by using the DB 40a, and writes journals concerning the depositing operations in the journal storage device 100. The receiving server 300 reads the journals written in the journal storage device 100 and generates written forms, statistical information and the like concerning deposits. Further, the transmitting server 200 and the receiving server 300 notify each other of the storage status of journals stored in the journal storage device 100.

Next, a second embodiment of the financial information processing system 1a will be described by way of example in which a transmitting server 200 performs weekday operations and a receiving server 300 performs weekend operations.

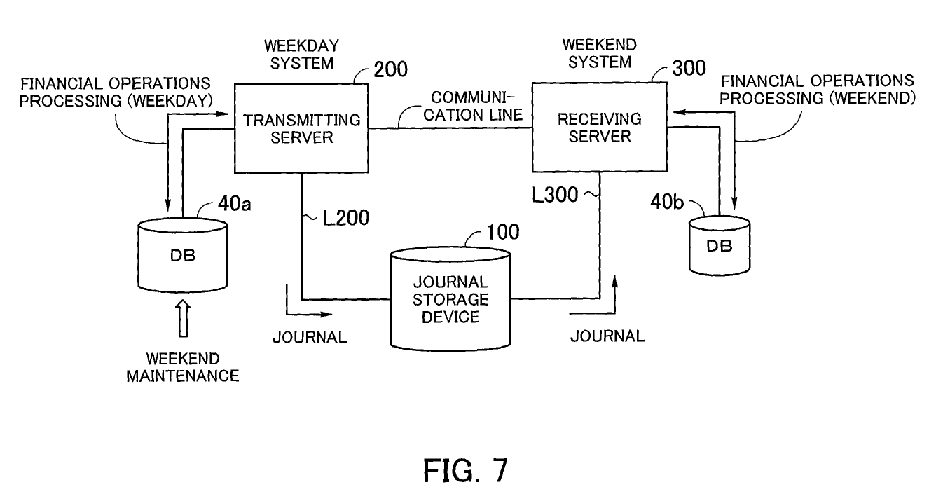

FIG. 7 is a conceptual representation of the second embodiment. The transmitting server 200, which has a large DB 40a, and the receiving server 300, which has a small DB 40b, share a journal storage device 100. Further, the transmitting server 200 and the receiving server 300 are connected by a communication line for transferring storage information of journals therebetween. The journal storage device 100 is connected to the transmitting server 200 and the receiving server 300 via respective communication lines L200, L300, respectively.

The transmitting server 200 performs financial operations by using the DB 40a on weekdays. The DB 40a is a large database, and hence maintenance thereof is necessary. However, it is not possible to perform maintenance operations for the DB 40a during operation of the transmitting server 200. Therefore, the transmitting server 200 writes journals concerning the financial operations in the journal storage device 100.

The receiving server 300 reads the journals written in the journal storage device 100 and performs financial operations by using the small DB 40b on weekends. This makes it possible to perform maintenance operations for the large DB 40a on weekends.

As described above, in the first and second embodiments, journals can be distributed immediately from the transmitting server 200 to the receiving server 300, which enables a system employed in a huge finical institution to efficiently carry out operations by linkage of data (journals) between the servers. Moreover, it becomes unnecessary to store identical journals in each of the servers in a duplicating manner.

Although in the above embodiments, the data linking system 1 is applied to the information processing system used in a finical institution, this is not limitative, but the system 1 may be applied to other kinds of information processing systems. The utilization of the present invention makes it possible to distribute data or journals immediately from a base system to information systems for users or customers, thereby enabling the information systems to constantly use the data or journals in an updated state.

As described above, the data linking system of the invention is comprised of a data storage device for storing data, a transmitter-side data linking apparatus for writing data into the data storage device, and a receiver-side data linking apparatus for reading data from the data storage device. This enables the transmitter-side data linking apparatus and the receiver-side data linking apparatus to share data, whereby it is possible to obtain the same effects as obtained when high-speed transfer of a large amount of data is carried out between the apparatuses.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be resorted to, falling within the scope of the invention in the appended claims and their equivalents.

What is claimed is:

1. A data linking system for linking data between a transmitter side and a receiver side, comprising:
a data storage device for storing said data;
a transmitter-side data linking apparatus including transmitter-side storage information management means for managing storage information concerning control of storage of said data in said data storage device, transmitter-side storage information interface means for transmitting and receiving said storage information for linkage with said receiver side, and data writing means for writing said data into said data storage device based on said storage information; and
a receiver-side data linking apparatus including receiver-side storage information management means for managing said storage information concerning control of storage of said data in said data storage device, receiver-side storage information interface means for transmitting and receiving said storage information for linkage with said transmitter side, and data reading means for reading said data from said data storage device based on said storage information.

2. A data linking system according to claim 1, wherein said transmitter-side storage information management means and said receiver-side storage information management means each manage a writing start number for use in writing said data into said data storage device and a reading end number for use in reading said data from said data storage device.

3. A data storage device for storing data, comprising:
data interface means for performing interfacing for writing or reading of said data; and
data storage means for storing said data.

4. A transmitter-side data linking apparatus for linking data, comprising:
transmitter-side storage information management means for managing storage information concerning control of storage of said data in a data storage device arranged outside said transmitter-side data linking apparatus;
transmitter-side storage information interface means for transmitting and receiving said storage information for linkage with a receiver side; and
data writing means for writing said data into said data storage device based on said storage information.

5. A receiver-side data linking apparatus for linking data, comprising:
receiver-side storage information management means for managing storage information concerning control of storage of said data in a data storage device arranged outside said receiver-side data linking apparatus;
receiver-side storage information interface means for transmitting and receiving said storage information for linkage with a transmitter side; and
data reading means for reading said data from said data storage device based on said storage information.

6. A financial information processing system for processing financial information for a financial institution,
the financial information processing system comprising:
a journal storage device for storing journals related to said financial institution;
a transmitter-side processing apparatus including transmitter-side storage information management means for managing storage information concerning control of storage of said journals in said journal storage device, transmitter-side storage information interface means for transmitting and receiving said storage information for linkage with a receiver side, and journal writing means for writing said journals into said journal storage device based on said storage information; and
a receiver-side processing apparatus including receiver-side storage information management means for managing said storage information concerning control of storage of said journals in said data storage device, receiver-side storage information interface means for transmitting and receiving said storage information for linkage with a transmitter side, and journal reading means for reading said journals from said journal storage device based on said storage information.

7. A financial information processing system according to claim 6, wherein said transmitter-side storage information management means and said receiver-side storage information management means each manage a writing start number for use in writing said journals into said journal storage device and a reading end number for use in reading said journals from said journal storage device.

8. A financial information processing system according to claim 6, wherein said transmitter-side processing apparatus and said receiver-side processing apparatus perform processing for linking between accounting-related operations and information-related operations or between weekday operations and weekend operations, via said journal storage device.

9. A journal storage device for storing journals related to financial information for a financial institution,
the journal storage device comprising:
journal interface means for performing interfacing for writing or reading of said journals; and
journal storage means for storing said journals.

10. A transmitter-side processing apparatus for linking journals related to financial information for a financial institution, and thereby performing finance-related operations,
the transmitter-side processing apparatus comprising:
transmitter-side storage information management means for managing storage information concerning control of storage of said journals in a journal storage device arranged outside said transmitter-side processing apparatus;
transmitter-side storage information interface means for transmitting and receiving said storage information for linkage with a receiver side; and
journal writing means for writing said journals into said journal storage device based on said storage information.

11. A receiver-side processing apparatus for linking journals related to financial information for a financial institution, and thereby performing finance-related operations,
the receiver-side processing apparatus comprising:
receiver-side storage information management means for managing storage information concerning control of storage of said journals in a journal storage device arranged outside said receiver-side processing apparatus;
receiver-side storage information interface means for transmitting and receiving said storage information for linkage with a transmitter side; and
journal reading means for reading said journals from said journal storage device based on said storage information.
